(19) United States
(12) Patent Application Publication
(10) Pub. No.: US 2026/0073131 A1
(43) Pub. Date: Mar. 12, 2026

(54) Generation of Context-Based Text Content

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/830,151

(22) Filed: Sep. 10, 2024

(51) Int. Cl. G06F 40/20

(52) U.S. Cl. CPC G06F 40/20

(57) ABSTRACT

Methods, systems, devices, and non-transitory computer readable media for generating context-based text content are provided. The disclosed technology can include receiving content data comprising content associated with one or more data modalities. One or more associated with the content data can be determined. Based on inputting the content data and context data based on the one or more contexts into one or more machine-learned models, one or more context-based text segments based on the content data can be generated. The one or more machine-learned models can be configured to generate the one or more context-based text segments based on recognition of one or more features of the content data and the context data. Furthermore, context-based text content based on the one or more context-based text segments can be generated.

### FIELD

The present disclosure relates generally to generating context-based text content based on content that can be associated with various data modalities. More particularly, the present disclosure relates to the use of machine-learned models to generate context-based text content based on the detection, recognition, or classification of features in content that can comprise images, text, audio, video, or multimodal inputs.

### BACKGROUND

A variety of content may be distributed through the Internet. In particular, social media is widespread and may be used to distribute content that may be used in a variety of different applications. Social media may include images, audio, or video that is selected by a user and sent to other users of a social media platform or received from other users of the social media platform. However, the process of sifting through large amounts of information and manually selecting and adding relevant information to the social media content can be time consuming and involve interaction with complex user interfaces. Accordingly, there may be different approaches to managing or creating social media content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating context-based text content. The computer-implemented method can comprise receiving, by a computing system comprising one or more processors, content data comprising content associated with one or more data modalities. The computer-implemented method can comprise determining, by the computing system, one or more contexts associated with the content data. The computer-implemented method can comprise generating, by the computing system, based on inputting the content data and context data based on the one or more contexts into one or more machine-learned models, one or more context-based text segments associated with the content data. The one or more machine-learned models can be configured to generate the one or more context-based text segments based on recognition of one or more features of the content data and the context data. Furthermore, the computer-implemented method can comprise generating, by the computing system, context-based text content based on the one or more context-based text segments.

Another example aspect of the present disclosure is directed to one or more tangible non-transitory computer-readable media storing computer-readable instructions that when executed by one or more processors cause the one or more processors to perform operations. The operations can comprise receiving content data comprising content associated with one or more data modalities. The operations can comprise determining one or more contexts associated with the content data. The operations can comprise generating, based on inputting the content data and context data based on the one or more contexts into one or more machine-learned models, one or more context-based text segments associated with the content data. The one or more machine-learned models can be configured to generate the one or more context-based text segments based on recognition of one or more features of the content data and the context data. Furthermore, the operations can comprise generating context-based text content based on the one or more context-based text segments.

Another example aspect of the present disclosure is directed to a computing system comprising: one or more processors; one or more non-transitory computer-readable media storing instructions that when executed by the one or more processors cause the one or more processors to perform operations. The operations can comprise receiving content data comprising content associated with one or more data modalities. The operations can comprise determining one or more contexts associated with the content data. The operations can comprise generating, based on inputting the content data and context data based on the one or more contexts into one or more machine-learned models, one or more context-based text segments associated with the content data. The one or more machine-learned models can be configured to generate the one or more context-based text segments based on recognition of one or more features of the content data and the context data. Furthermore, the operations can comprise generating context-based text content based on the one or more context-based text segments.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can generate context-based content comprising context-based text segments according to example embodiments of the present disclosure;

FIG. 1B depicts a block diagram of an example computing device that generates context-based content comprising context-based text segments according to example embodiments of the present disclosure;

FIG. 1C depicts a block diagram of an example computing device that generates context-based content comprising context-based text segments according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of generating context-based text content based on location context according to example embodiments of the present disclosure;

FIG. 5 depicts an example of generating context-based text content based on temporal context according to example embodiments of the present disclosure;

FIG. 6 depicts an example of generating context-based text content based on event context according to example embodiments of the present disclosure;

FIG. 7 depicts an example of generating context-based text content based on application context according to example embodiments of the present disclosure;

FIG. 8 depicts an example of generating context-based text content based on user context according to example embodiments of the present disclosure;

FIG. 9 depicts an example of a link note based on context-based text content according to example embodiments of the present disclosure;

FIG. 10 depicts a flow chart diagram of an example method of generating context-based text content according to example embodiments of the present disclosure; and

FIG. 11 depicts a flow chart diagram of an example method of training machine-learned models to generate context-based text segments according to example embodiments of the present disclosure.

Reference numerals that are repeated across plural figures are intended to identify the same features in various implementations.

### DETAILED DESCRIPTION

In general, the present disclosure is directed to generating context-based text content based on the detection, recognition, and/or classification of features (e.g., visual features and/or audio features) in content data associated with one or more data modalities (e.g., images, audio, text, and/or video). Further, the disclosed technology can generate context-based text content based in part on context associated with content. In particular, the context-based text content can be automatically generated based on content and one or more contexts including a location, time, event, application, search information (e.g., a search history which can include recent search queries), and/or user associated with the content. In some embodiments, the context-based text content can be based in part on a prompt (e.g., a user prompt) associated with the content. Additionally, the disclosed technology can implement machine-learned models (e.g., generative machine-learned models that can comprise transformer models and/or diffusion models) that have been configured and/or trained to generate context-based text segments based on the detection, recognition, and/or classification of features in content associated with one or more data modalities. The context-based text segments can be included in context-based text content that can be included in a link note that can be shared with other users and/or associated with a web resource (e.g., a social media post or a search result).

For example, a computing system can receive content data that can comprise content associated with one or more data modalities. In particular, the content can comprise images, audio segments, and/or video segments. For example, the content can comprise an image of a birthday cake with lit candles that a user captured using a camera of the user’s smartphone. The computing system can then determine one or more contexts associated with the content data. For example, the content data comprising the image of the birthday cake can comprise location data that indicates the location (e.g., geographic location) at which the image of the birthday cake was captured. Further, the content data can be associated with a particular application (e.g., a social media application) that is used to post images to a user’s social media account. The image content data and context data based on the one or more contexts can then be inputted into one or more machine-learned models, that can generate one or more context-based text segments. The context-based text references can comprise one or more references to the context associated with the content data. The one or more machine-learned models can be configured and/or trained to generate the text segments based on the detection, recognition, and/or classification of features of the content data, context data, and/or prompt data that can comprise and/or be based on one or more prompts. For example, the one or more machine-learned models can be configured and/or trained to detect, recognize, and/or classify visual features in images (e.g., recognize faces and/or objects in images) and generate context-based text segments based on the images and the context associated with the images. In some embodiments, the one or more machine-learned models can comprise a generative language model (e.g., a large language model (LLM)) that is configured and/or trained to generate the context-based text segments based on input comprising content data, context data, and/or prompt data that can comprise or be based on one or more prompts.

The disclosed technology can then generate context-based text content based on the one or more text-segments. For example, content comprising an image of a birthday cake can include context-based text content that includes a congratulatory message to the birthday cake recipient that includes contextual information such as the restaurant at which the birthday cake was presented, the name of the birthday cake recipient, and a humorous quip about birthdays. Further, the disclosed technology can generate a link note based on the context-based text content. The link note can include the context-based text content and a link to a web resource (e.g., a web page or social media post). For example, the link note can comprise a captioned image with a link to the social media post from which the image was obtained. Further, the link note can be shared with other users and/or included in a web resource. For example, the link note can be sent to one or more users in a user group of contacts.

The context-based text content can be used in a variety of applications including social media applications. The ability to effectively generate context-based content allows various types of content to be used in various applications. As such, the disclosed technology allows for improved generation of context-based content that can be used in a variety of applications including social media applications, texting applications, email applications, online forum applications, and/or various types of other communication applications.

Accordingly, the disclosed technology can automatically generate context-based text content that can be used to provide relevant text based on content data associated with various data modalities. Further, the disclosed technology can assist a user in more effectively and/or safely performing the technical task of content (e.g., content comprising images, audio segments, and/or video segments) by means of a continued and/or guided human-machine interaction process in which images are received and the disclosed technology generates real-time context-based text content based on continuously updated context information. For example, a user can use a smartphone to capture an image that determines a context associated with the image (e.g., the location at which the image was captures) and sends the image and the context data to a remote machine-learned model system that generates context-based text content based on the image and sends the context-based text content back to the user’s smartphone.

The disclosed technology can be implemented in a computing system (e.g., a text generation computing system) that is configured to access data and/or perform operations on the data. For example, the operations performed by the computing system can comprise receiving content data associated with one or more data modalities, receiving prompt data comprising one or more prompts, determining contexts associated with the content data, generating, based on inputting the content data, the prompt data, and/or context data based on the one or more contexts into one or more machine-learned models, one or more context-based text segments based on the content data, and/or generating context-based text content based on the one or more context-based text segments. Further, the computing system can leverage one or more machine-learned models that have been configured and/or trained to process (e.g., detect, recognize, and/or classify) input comprising content data, context data, and/or prompt data that can comprise or be based on one or more prompts and generate one or more context-based text segments based on features in the input (e.g., features of the content data, context data, and/or prompt data).

The computing system can be included as part of a system that includes a server computing device that receives data (e.g., content data comprising images, audio segments, and/or video segments) from a user’s client computing device, performs operations based on the data and sends output comprising text segment data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the detection, recognition, and/or classification of content data comprising images, audio segments, and/or video segments; the generation of context-based text segments based on the content data, prompt data comprising or based on one or more prompts, and/or context data, and/or the generation of context-based content based on the context-based text segments.

The computing system can receive, access, and/or retrieve content data. The content data can comprise content that can be associated with one or more data modalities. For example, the content data can comprise one or more images, one or more audio segments, and/or one or more video segments. For example, the content data can comprise an image captured by a computing device of a user or an audio segment received from an online music repository. The content data can comprise metadata that can be used to determine context associated with the content data. For example, the content data can comprise location data that can indicate a location at which content data was generated (e.g., the location an image was captured and/or audio was recorded). In some embodiments, the computing system can be configured to deduplicate the content data that is received. For example, if one or more copies of the same content (e.g., the same image, audio segment, or video segment) are received, the computing system can remove the duplicate copies of the content.

The computing system can receive, access, and/or retrieve prompt data and/or one or more prompts. The prompt data can comprise and/or be based on one or more prompts. For example, the computing system can generate prompt data based on one or more prompts inputted by a user into the computing system via an input device (e.g., a keyboard). The one or more prompts can be associated with the content data. Further, the one or more prompts can comprise one or more indications (e.g., text-based instructions and/or spoken instructions) from a user. The one or more prompts can be entered via an input device (e.g., keyboard and/or microphone). For example, if the content data comprises an image of a dog, the prompt might indicate “GENERATE AN AMUSING COMMENT ABOUT MY DOG.” The one or more prompts can comprise one or more links (e.g., hyperlinks). Further, the one or more prompts can comprise a link to a web page that comprises the content and/or information associated with the content. For example, the one or more prompts can comprise a recipe or the title of the recipe along with a link to a webpage that includes the entire recipe and/or other related recipes. In some embodiments, the one or more prompts can be based on one or more search results and/or one or more search queries. For example, a search query (e.g., interesting information about this city) can be included with content comprising an image of an unknown or unfamiliar city.

The computing system can determine one or more contexts. The one or more contexts can be associated with the content data. The computing system can determine the one or more contexts based on searching and/or processing data comprising location data, temporal data, event data, application data, search data, and/or information associated with a user. For example, the computing system can process metadata that is included in the content data and comprises indications of where the content data was generated and/or modified, one or more entities that generated and/or modified the content data (e.g., a user that generated and/or modified the content data), one or more times that the content data was generated or modified, a search history and/or search queries associated with the content data, and/or an application that accessed, generated, and/or modified the content data. Context data can be generated and/or determined based on the one or more contexts. The context data can comprise information and/or data associated with the one or more contexts. For example, the computing system can access the one or more contexts and/or information (or data) associated with the one or more contexts and generate and/or determine context data based on the one or more contexts. Further, the context data can be based on and/or comprise one or more contexts comprising one or more web browsing histories, one or more purchase histories, user profile data (e.g., profile data indicating the web services a user is associated with), and/or a link note history (e.g., a history of one or more link notes that a user generated, modified, sent, received, and/or viewed).

The computing system can generate and/or determine one or more context-based text segments. The one or more context-based text segments can be based on the content data, the context data, and/or the prompt data (e.g., one or more prompts included in the prompt data). The one or more context-based text segments can be generated based on inputting the content data, the context data, and/or the prompt data (e.g., prompt data associated with one or more prompts) into one or more machine-learned models. The one or more machine-learned models can be configured and/or trained to generate and/or determine the one or more context-based text segments based on input comprising the content data, the context data, and/or the prompt data. Further, the one or more machine-learned models can be configured and/or trained to detect, recognize, and/or classify one or more features of the content data, the context data, and/or the one or more prompts.

In some embodiments, a computing system can determine the one or more contexts based on information associated with one or more locations. For example, information associated with the one or more locations can be based on location data that can be associated with one or more locations (e.g., latitude, longitude, and/or altitude) at which the content data was generated and/or modified. The location data can be included in the content data, in the application that generated the content data (e.g., a camera application that generated content data comprising image content and/or a social media application that generated content data comprising image content). Further, the one or more machine-learned models can be configured and/or trained to generate the one or more context-based text segments based on the information associated with the one or more locations. For example, the one or more machine-learned models can determine location data comprising an address associated with the one or more locations, geographic coordinates associated with the one or more locations, and/or a personalized reference (e.g., Dad’s house) associated with the one or more locations. Further, one or more machine-learned models can generate the one or more context-based text segments based on the location data. For example, if the context indicates that a location is a swimming pool, the one or more context-based text segments generated by the one or more machine-learned models can indicate “HAD A GREAT TIME AT THE POOL.”

In some embodiments, a computing system can determine the one or more contexts based on one or more temporal indications associated with one or more times at which the content data was generated. For example, information associated with the one or more temporal indications can comprise time stamps that indicate one or more times at which the content data was generated and/or modified. The one or more temporal indications can be included in the content data, in the application that generated the content data (e.g., a web browser that indicates the time at which content data comprising an image, audio, and/or video was downloaded). Further, the one or more machine-learned models can be configured and/or trained to determine the one or more context-based text segments based on the one or more times. For example, the one or more machine-learned models can be configured and/or trained to determine that an image was captured at a particular time of day and can generate one or more context-based text segments that refer to the time of day. For example, if the context indicates that content was generated at 10:00 p.m. and the location information associated with the content data indicates that the content was generated in the city of Paris, the one or more context-based text segments can indicate “A BEAUTIFUL PARIS EVENING.”

In some embodiments, a computing system can determine the one or more contexts based on information associated with one or more events associated with the content data. For example, information associated with the one or more events can comprise identifiers (e.g., the name of an event) and/or classes (e.g., birthday party) associated with one or more events. Further, the one or more machine-learned models can be configured and/or trained to generate the one or more context-based text segments based on the one or more events. For example, if the context indicates that the content was generated at a high-school dance at a Grammar school, the one or more context-based text segments can indicate “GOOD TIMES AT THE GRAMMAR SCHOOL DANCE.”

In some embodiments, a computing system can determine the one or more contexts based on information associated with one or more applications associated with the content data. For example, the information associated with the one or more applications can comprise web browser data that indicates the times at which content data was downloaded or viewed, text message application data that can include the content of text messages (e.g., text, images, audio, and/or video content), email application data that can comprise the content of email messages, and/or social media application data that indicates social media postings that can be associated with the content data. The one or more machine-learned models can be configured and/or trained to generate the one or more context-based text segments based on the one or more applications. Further, the one or more machine-learned models can be configured and/or trained to detect, recognize, and/or classify the information associated with the one or more applications and generate the one or more context-based text segments based on the information associated with the one or more applications. For example, if the content comprises an image of a sports car and the context indicates that content was generated by a particular social media application and the information associated with the social media application indicates that image of the sports car was captured at a car show in the city of Detroit, the one or more context-based text segments can indicate “A GREAT LOOKING VEHICLE AT THE DETROIT AUTO SHOW.”

In some embodiments, a computing system can determine the one or more contexts based on one or more search queries and/or search results associated with the content data. For example, the information associated with the one or more search queries can comprise web browser data that indicates search queries associated with a user and/or a search history associated with a user. The one or more machine-learned models can be configured and/or trained to recognize and/or classify the one or more search queries and/or search history and generate the one or more context-based text segments based on the one or more search queries. For example, if the context is based on a search result for Fujian peanut noodle recipes, and the content comprises an image of a bowl of noodles with no indication of the type of noodles, the one or more context-based text segments can indicate “DELICIOUS FUJIAN PEANUT NOODLES.”

In some embodiments, a computing system can determine the one or more contexts based on information associated with one or more users associated with the content data. For example, the information can be based on data associated with a user logged into an application (e.g., a social media application) and/or an online account (e.g., an account for a web service). Further, the one or more machine-learned models can be configured and/or trained to generate the one or more context-based text segments based on the information associated with the one or more users. For example, if the context is based on a particular user sending a message to another user (e.g., a user named “Sam”) and the content includes an image of a vehicle the user is considering buying, the one or more context-based text segments can indicate “HEY SAM, WHAT DO YOU THINK ABOUT THIS CAR?”

The one or more machine-learned models can comprise one or more multimodal generative models (e.g., one or more multimodal transformer models) that are trained to generate the one or more context-based text segments based on training data. The training data can comprise training content data and/or training context data. The training content data can comprise a plurality of training images, a plurality of training audio segments, a plurality of training video segments, and/or a corresponding plurality of ground-truth text segments. Further, the training context data can comprise a plurality of training locations, a plurality of temporal indications, a plurality of training applications, a plurality of training identified users, a plurality of training search results, and/or a plurality of training search queries. In some embodiments, the training data can comprise a plurality of embeddings. The plurality of embeddings can comprise a lower-dimensional vector space representation of the training data. For example, training images can be represented in a lower-dimensional vector space that can preserve key features of the images in a smaller dimensional vector space than the higher-dimensional vector space of the original image (e.g., a high-dimensional vector space that can include RGB values for the millions of pixels in an image). The plurality of embeddings can be arranged such that semantically similar content is closer together in the vector space. The plurality of embeddings can be generated based on the training content data and/or training context data. For example, the plurality of embeddings can be generated based on inputting the training data into one or more machine-learned models configured and/or trained to generate the plurality of embeddings.

The one or more machine-learned models can be trained based on training data comprising a plurality of training context-based text segments of a user associated with the content data. The one or more machine-learned models can be configured and/or trained to generate the context-based text content in a visual style based on the plurality of training context-based texts. For example, the one or more machine-learned models can be configured and/or trained to generate context-based text segments in a particular visual style based on training data comprising social media posts of a user and/or other user generated content that has a particular visual style. The visual style can comprise a color scheme and/or one or more font types of the one or more context-based text segments. For example, a visual style can comprise color variations (e.g., bright colors, muted colors, earth tones, and/or pastels), borders around content, and/or background images. The one or more font types can comprise particular type faces (e.g., Helvetica or Times New Roman), the use bold fonts, underlining, various font sizes, and/or drop shadows on text.

The one or more machine-learned models can be trained to generate the one or more context-based text segments based on training data comprising a plurality of training text segments of a user associated with the content data. For example, the one or more machine-learned models can be configured and/or trained to generate context-based text segments in the users writing style based on training data comprising social media posts of a user, text messages of a user, and/or email messages of a user. The training data can be used after receiving the express consent of the user and after notifying the user that the training data can be used to train a machine-learning model.

The one or more machine-learned models can be trained to generate the one or more context-based text segments based on training data comprising a plurality of training text segments of a user associated with the content data. For example, the one or more machine-learned models can be configured and/or trained to generate context-based text segments that comprise one or more structured text segments based on training data comprising training images, training audio segments, and/or training video segments. The training data can be associated with corresponding ground-truth structured text segments that are based on transcription of audio in the training audio segments and/or training video segments, and/or optical character recognition of text detected in the training text segments. The one or more structured text segments can comprise text that is organized. For example, the one or more structured text segments can comprise a set of steps (e.g., a recipe to prepare food, a to-do list, and/or instructions to assemble furniture) that can be associated with an activity.

The one or more context-based text segments can comprise one or more text segments that are associated with the content data, the context data, and/or one or more prompts. For example, one or more context-based text segments can comprise a description of an image, a description of audio, and/or a description of video; an indication of opinion about content (e.g., liking an image, liking a video segment, and/or disliking an audio segment); and/or a rating or review of content (e.g., a rating of a song or a review of a book). In some embodiments, the one or more context-based text segments can comprise pictograms, logographs, and/or ideograms. For example, the one or more context-based text segments can comprise one or more emojis and/or one or more emoticons.

The one or more machine-learned models can be configured and/or trained to perform one or more object processing operations (e.g., object detection operations) to detect, recognize, and/or classify one or more objects in the content data (e.g., content data comprising one or more images and/or one or more video segments). The one or more machine-learned models can be configured and/or trained to generate the one or more context-based text segments based on the detection, recognition, and/or classification of one or more objects in the content data. For example, the one or more machine-learned models can detect one or more faces in input comprising content data comprising an image of a group of people. The one or more machine-learned models can then generate one or more context-based text segments associated with the one or more faces that were detected. Further, one or more machine-learned models can be configured and/or trained to perform one or more object detection operations to detect, recognize, and/or classify one or more objects in the content data (e.g., content data comprising one or more images and/or one or more video segments). For example, the one or more machine-learned models can detect vehicles in content data comprising an image of a group of vehicles.

The one or more machine-learned models can be configured and/or trained to perform one or more audio processing operations to detect, recognize, and/or classify one or more audio features of the content data (e.g., content data comprising audio segments associated with music or speech). The one or more machine-learned models can be configured and/or trained to generate the one or more context-based text segments based on the detection, recognition, and/or classification of one or more audio features of the content data. For example, the one or more machine-learned models can detect speech in input comprising content data comprising an audio segment of a conversation between a group of people.

The computing system can generate context-based text content. The context-based text content can be based on the one or more context-based text segments. For example, the context-based text content can comprise an image (e.g., an image from the content data) and a description of the image, a sound segment (e.g., music from the content data) and a text based greeting to accompany the music, and/or a video segment (e.g., a video segment from the content data) and a text-based message associated with the video segment and the sender of the video segments. Further, the context-based text content can be generated in a format based on a type of application that will use the context-based text content. For example, the context-based text content can be formatted for inclusion in a posting for a social media application.

In some embodiments, the one or more machine-learned models can be configured and/or trained to generate the one or more context-based text segments. Training the one or more machine-learned models to generate the one or more context-based text segments can comprise receiving training data. The training data can comprise training content data, training context data, and/or a corresponding plurality of ground-truth text segments.

The training content data can comprise a plurality of training data inputs that can comprise a plurality of training images, a plurality of training text segments, a plurality of training audio segments, and/or a plurality of training video segments. The context training data can comprise a plurality of training locations associated with the training content data, a plurality of temporal indications associated with the training content data, training application information associated with the training content data, a plurality of search queries and search histories associated with the training content data, user information associated with the training content data, and/or training event data associated with the training content data. In some embodiments, the training data can comprise a plurality of embeddings based on output from an embedding generation model that generated the plurality of embeddings based on the training data.

The plurality of ground-truth text segments can represent text segments that accurately correspond to a training data input. For example, the plurality of training images can include a plurality of images of vehicles and people associated with a corresponding plurality of ground-truth text segments that accurately describe the vehicles and people in the plurality of training images. Further, the plurality of ground-truth text segments can accurately indicate types of activities, types of environments, and/or classes of content associated with training images, training audio, and/or training video.

Further, training the one or more machine-learned models can comprise generating and/or determining, based on inputting the training data into the one or more machine-learned models, a plurality of predicted text segments. Based on the received input, the one or more machine-learned models can perform one or more operations and generate an output comprising a plurality of predicted text segments associated with the corresponding plurality of training data inputs. The output of the one or more machine-learned models can then be evaluated based on one or more comparisons of the plurality of predicted text segments to a corresponding plurality of ground-truth text segments associated with the training data.

Training the one or more machine-learned models can comprise determining a loss based on one or more differences between the plurality of predicted text segments and the plurality of ground-truth text segments. For example, a loss function can be used to determine the loss. The loss function can be used to evaluate the one or more differences between the plurality of predicted text segments and the plurality of ground-truth text segments. The loss can increase in proportion to the number of the one or more differences between the plurality of predicted text segments and the plurality of ground-truth text segments. For example, if there are ten differences between the plurality of predicted text segments and the plurality of ground-truth text segments, the loss can be greater than if there are three differences between the plurality of predicted text segments and the plurality of ground-truth text segments.

Further, the loss can increase in proportion to the magnitude of differences between the plurality of predicted text segments and the plurality of ground-truth text segments. For example, a predicted text segment that is very different from a ground-truth text segment (e.g., a predicted text segment that very inaccurately describes an image) can result in a greater loss than a predicted segment that is slightly different from a ground-truth text segment (e.g., a predicted text segment that comprises a slightly inaccurate description of an image). For example, a predicted text segment that inaccurately describes an image of a dog drinking from a bowl as an image of a bulldozer can be associated with a greater loss than a predicted text segment that inaccurately describes an image of a dog drinking from a bowl as an image of a cat drinking from a bowl.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the predicted text segments. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameter can be associated with the plurality of predicted text segments such that parameters that are more heavily weighted can contribute more to determining the predicted text segments than parameters that are less heavily weighted. Over the plurality of iterations, the weights of the plurality of parameters can be modified to minimize the loss until a threshold loss that corresponds to a high accuracy of the one or more machine-learned models determining the plurality of predicted text segments is achieved. For example, the loss can be minimized until a threshold loss associated with 99% accuracy is achieved by the machine-learned model.

The computing system can generate a link note. A link note can be based on the context-based text content. Further, the link note can comprise one or more portions of the context-based content (e.g., the content and the one or more context-based text segments, the content, and/or the one or more context-based text segments) and/or one or more links (e.g., one or more hyperlinks) to one or more web resources that can be associated with the context-based text content. The one or more web resources can comprise resources that are accessible via a network (e.g., the Internet). The one or more web resources can comprise one or more search results, one or more web pages, one or more database entries, one or more documents, and/or one or more social media posts. For example, the context-based text content can be based on content (e.g., an image of a cat) from a social media post and the link note can comprise the context-based content including one or more context-based text segments indicating how beautiful the cat is and a link to the social media post from which the content was obtained.

Further, the link note can comprise information associated with a time the link note was generated and/or sent, a user associated with the link note (e.g., the user that generated the link note and/or a recipient of the link note), a location at which the link note was generated, an application that was used to generate the link note, and/or an email address associated with the link note (e.g., the email address of an individual user or business associated with the link note). One or more portions of the information in the link note can be selectively shared based on the preferences of the user sharing the link note. For example, a user can share their email address in link notes sent to one group of users and not share their email address in the link notes sent to a different group of users.

In some embodiments, the link note can be sent to one or more users and/or embedded in a web resource (e.g., a webpage). For example, a link note can be shared with one or more users from the sender of the link note’s contact list. Further, a link note can be embedded in a social media post, an online review, an online forum post, and/or a search result. For example, a link note comprising an image of a movie poster and a brief text segment praising the movie in the poster can be included in a movie review that can be provided as the result of a search for a review about that particular movie.

The systems, methods, devices, and/or computer-readable media (e.g., tangible non-transitory computer-readable media) in the disclosed technology can provide a variety of technical effects and benefits including an improvement in the effectiveness with which content data comprising images, audio, and/or video is classified based on the detection, recognition, and/or classification of features (e.g., low-level visual features and/or low-level audio features) of the content data. Further, improved generation of context-based text based on the detection, recognition, and/or classification of features of content data including images, audio, and/or video can assist a user by providing more accurate context-based text. The disclosed technology can also improve the effectiveness with which computational resources are used by leveraging one or more machine-learned models that are able to determine features (e.g., visual features and/or audio features) more efficiently.

Further, the disclosed technology can improve the effectiveness with which content is searched for, retrieved, and/or distributed from a variety of data sources. The large volume of content that is available on the Internet can present the arduous task of searching for relevant content. In many cases, the content a user searches for is irrelevant or deliberately misleading (e.g., misinformation). The ability to quickly generate content that can be shared with trusted users in the form of a link note can greatly reduce inefficiencies involved in the search and retrieval of information.

Additionally, the disclosed technology can automatically generate text segments based on the processing (e.g., classification) of features of content data including images, audio, and/or video. For example, an image that is intended for inclusion as part of social media content can be automatically classified and based in part on classification of the image and a context associated with the image (e.g., a destination webpage to which the social media content comprising the image can be posted), relevant text segments associated with the image can be generated using a machine-learned model. In this way, the time-consuming task of manually describing features of content data and/or adding relevant contextual image to the content data can be automatically performed by the disclosed technology.

As such, the disclosed technology can allow the user of a computing system to perform the technical task of generating text based on the detection, recognition, and/or classification of features of content data (e.g., images, audio, and/or video). As a result, users can be provided with the specific benefits of improved performance (classification performance and/or content generation performance) and more efficient use of system resources. Further, any of the specific benefits provided to users can be used to improve the effectiveness of a wide variety of devices and services including devices that use context-based text content. Accordingly, the improvements offered by the disclosed technology can result in tangible benefits to a variety of devices and/or systems including mechanical, electronic, and computing systems associated with generating context-based text content.

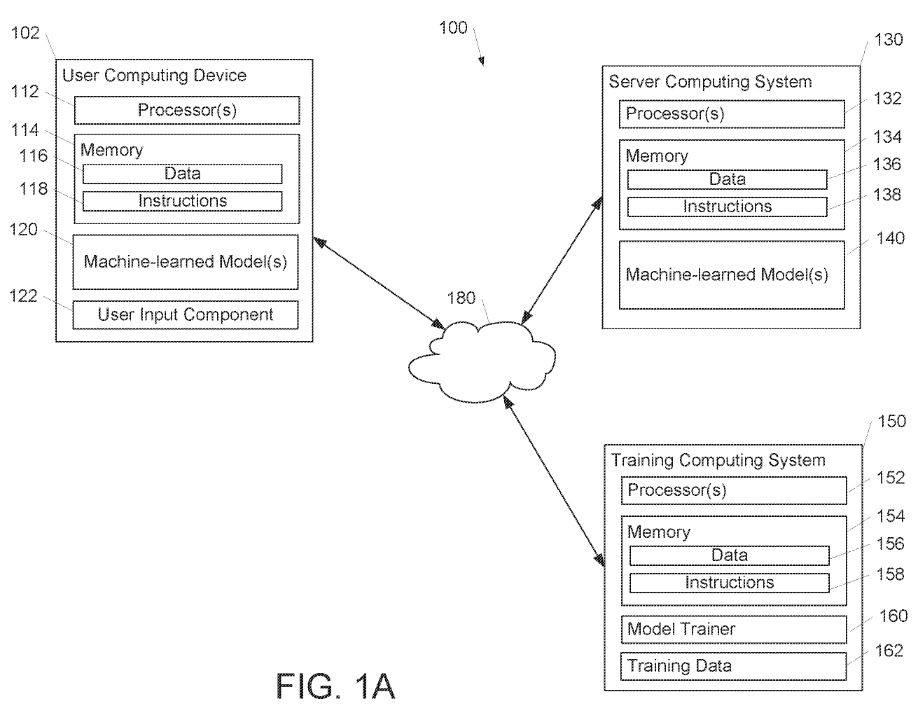

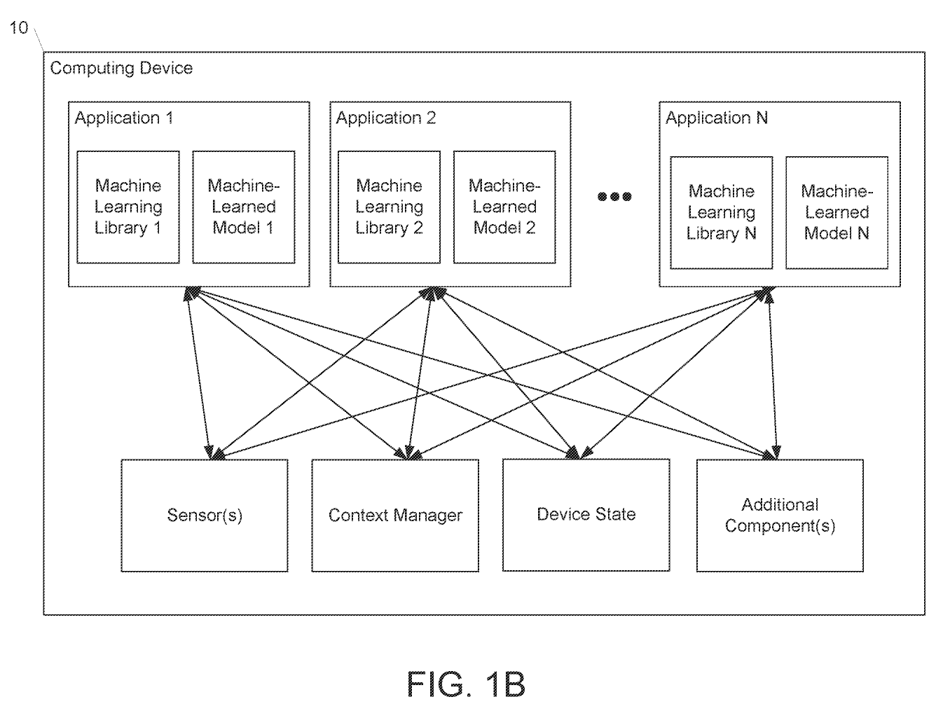

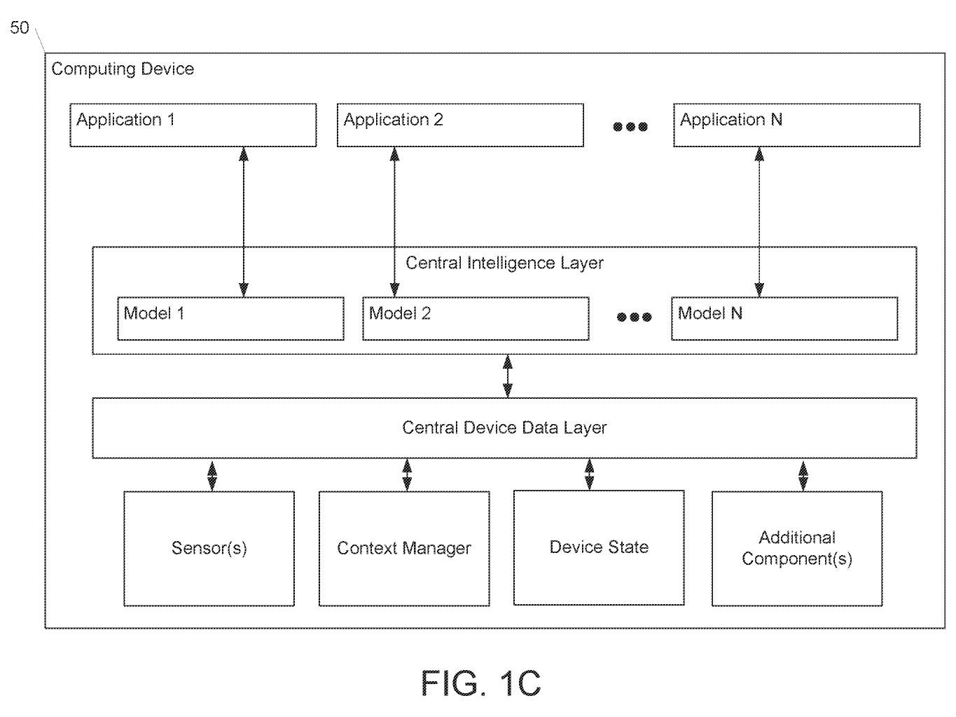

With reference now to the figures, example embodiments of the present disclosure will be discussed in further detail. FIG. 1A depicts a block diagram of an example of a computing system that can generate context-based text content according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more encoders, one or more decoders, and/or one or more embedding models. Examples of one or more machine-learned models 120 are discussed with reference to FIGS. 1-11.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel context-based text content generation operations across multiple instances of the one or more machine-learned models 120).

More particularly, the one or more machine-learned models 120 can comprise one or more machine-learned models (e.g., one or more LLMs) that are configured and/or trained to perform operations comprising receiving content data associated with one or more data modalities, determining contexts associated with the content data, generating, based on inputting the content data and/or context data based on the one or more contexts into a machine-learned model, one or more context-based text segments based on the content data, and/or generating context-based text content based on the one or more context-based text segments.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., content data processing service and/or a context-based text content generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-11.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include content data, context data, and/or other data that is associated with the detection, recognition, and/or classification of images, audio segments, and/or video segments; and the generation of text segments that can be used in context-based text content. For example, the training data 162 can comprise training content comprising a plurality of training images and a corresponding plurality of ground-truth text segments that accurately describes the plurality of training images; a plurality of training audio segments and a corresponding plurality of ground-truth text segments that accurately describes the plurality of training audio segments; and/or a plurality of training video segments and a corresponding plurality of ground-truth text segments that accurately describes the plurality of training video segments. Further, the training data 162 can comprise a plurality of training contexts that comprise information associated with contexts associated with the training content (e.g., locations, temporal indications, events, applications, search queries, and/or users associated with the training content). The model trainer 160 can train and/or retrain the one or more machine-learned models 120 and/or the one or more machine-learned models 140 based on additional data from the training data 162 which can comprise additional content data (e.g., updated content data), new types of content data (e.g., new types of content data based on new content formats), and/or one or more modifications to existing content data.

In some implementations, if a user has provided consent (e.g., the user provides affirmative consent for another party to use the user’s content data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification can be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task can be an audio compression task. The input can include audio data and the output can comprise compressed audio data. In another example, the input includes visual data (e.g., one or more images or videos), the output comprises compressed visual data, and the task is a visual data compression task. In another example, the task can comprise generating an embedding for input data (e.g., input audio data or visual data).

In some cases, the input includes audio data representing a spoken utterance and the task is a speech recognition task. The output can comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that generates context-based content comprising context-based text segments according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include a content data processing application, a context data processing application, a social media application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that generates context-based content comprising context-based text segments according to example embodiments of the present disclosure. A computing device 50 can be a user computing device or a server computing device.

The computing device 50 includes a number of applications (e.g., applications 1 through N). Each application is in communication with a central intelligence layer. Example applications include a content processing application (e.g., an application that is used to process content data and context data, generate text segments based on the content data and/or the context data, and generate context-based text content based on one or more context-based text segments), a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

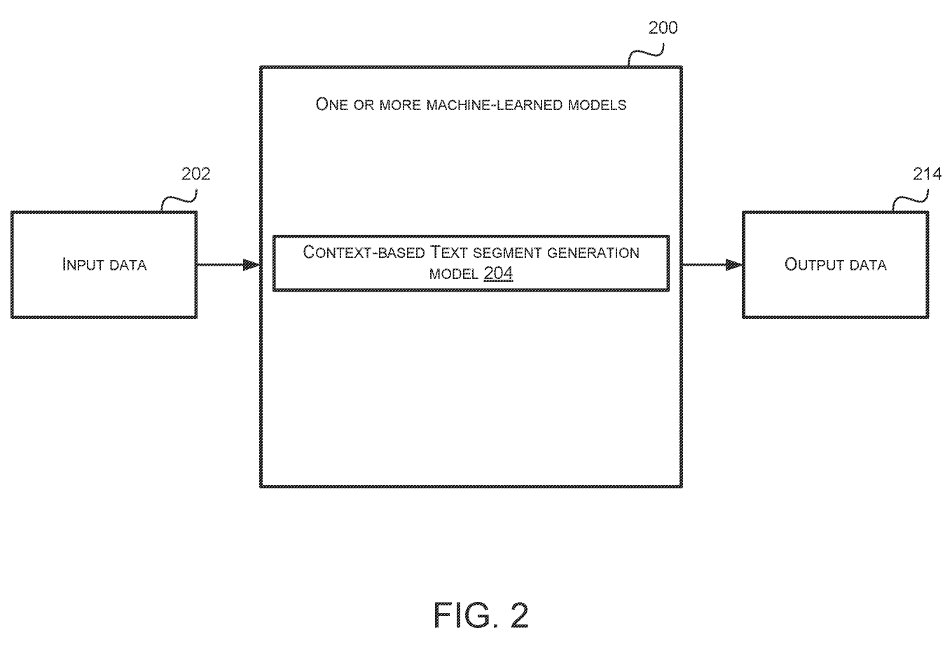

FIG. 2 depicts a block diagram of examples of machine-learned models according to example embodiments of the present disclosure. In some implementations, the one or more machine-learned models 200 can be trained to receive input data 202 that can comprise content data associated with one or more data modalities (e.g., images, audio segments, text segments, and/or video segments) and/or context data associated with the content data (e.g., location data, temporal data, event data, application data, search data, and/or information associated with a user). As a result of receipt of the input data 202 the one or more machine-learned models 200 can generate output data 214 that can comprise one or more context-based text segments based on detection, recognition, and/or classification of one or more features of the content data and/or the context data.

In some implementations, the one or more machine-learned models 200 can include a content processing model 204 that is operable to generate text segments based on the input data 202 (e.g., the content data and/or the context data).

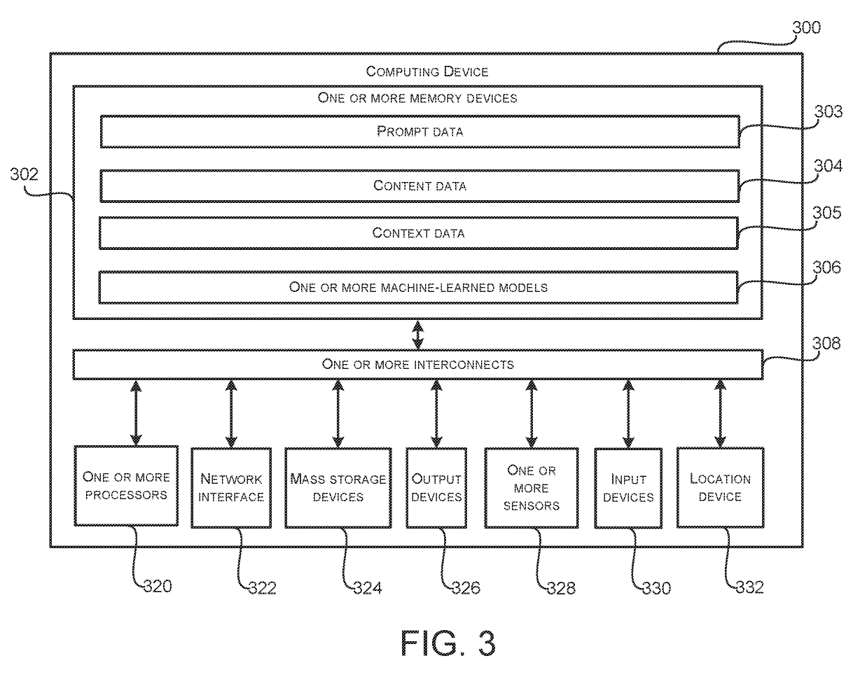

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, prompt data 303, content data 304, context data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., text segments) based on content detected by the one or more sensors 328 (e.g., images captured by a camera of the device 300) of the computing device 300 and/or data that is received from another computing device (e.g., content data that is generated by a remote computing device).

The one or more memory devices 302 can store information and/or data (e.g., the content data 304, the context data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations comprising receiving content data associated with one or more data modalities, determining contexts associated with the content data, generating, based on inputting the content data and/or context data based on the one or more contexts into a machine-learned model, one or more context-based text segments based on the content data, and/or generating context-based text content based on the one or more context-based text segments.

The prompt data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The prompt data 303 can be generated based on one or more inputs via the one or more input devices 330. For example, the prompt data can comprise text based on inputs via a keyboard (e.g., mechanical keyboard and/or touchscreen keyboard), touch inputs via a touchscreen, and/or audio input via a microphone. In some embodiments, the prompt data 303 can be received from one or more computing systems (e.g., the server computing system 130 that is depicted in FIG. 1) which can include one or more computing systems that are remote from the computing device 300. The prompt data 303 can comprise one or more text segments (e.g., a text prompt) and/or one or more audio segments (e.g., an audio prompt).

The content data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the content data 304 can be received from one or more computing systems (e.g., the server computing system 130 that is depicted in FIG. 1) which can include one or more computing systems that are remote from the computing device 300. The content data 304 can comprise one or more images, one or more audio segments, one or more video segments, and/or one or more text segments. Further, the content data 304 can comprise information associated with one or more locations at which content data 304 was generated, modified, and/or accessed; one or more times at which content data 304 was generated, modified, and/or accessed; one or more events associated with the content data 304; one or more applications associated with the content data 304; one or more search queries associated with the content data 304; and/or one or more users associated with the content data 304.

The context data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the context data 305 can include information associated with one or more contexts of the content data 304 and/or a user of the computing device 300 including location data, temporal data, event data, application data, search data, and/or information associated with a user. In some embodiments, the context data 305 can be received from one or more computing systems (e.g., the server computing system 130 that is depicted in FIG. 1) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can be configured and/or trained to perform comprising receiving content data associated with one or more data modalities, determining contexts associated with the content data, generating, based on inputting the content data and/or context data based on the one or more contexts into a machine-learned model, one or more context-based text segments based on the content data, and/or generating context-based text content based on the one or more context-based text segments. In some embodiments, the one or more machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the content data 304, the context data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the content data 304, the context data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., content data) from other computing devices. The one or more mass storage devices 324 (e.g., a hard disk drive and/or a solid-state drive) can be used to store data including the content data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images, audio segments, and/or video segments associated with the content data 304.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including context-based text content based on text segments. The one or more memory devices 302 can be used to operate various applications including a mobile operating system developed specifically for mobile devices. As such, the one or more memory devices 302 can store instructions that allow the software applications to access data including data associated with the generation of text segments associated with content data and/or the context data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

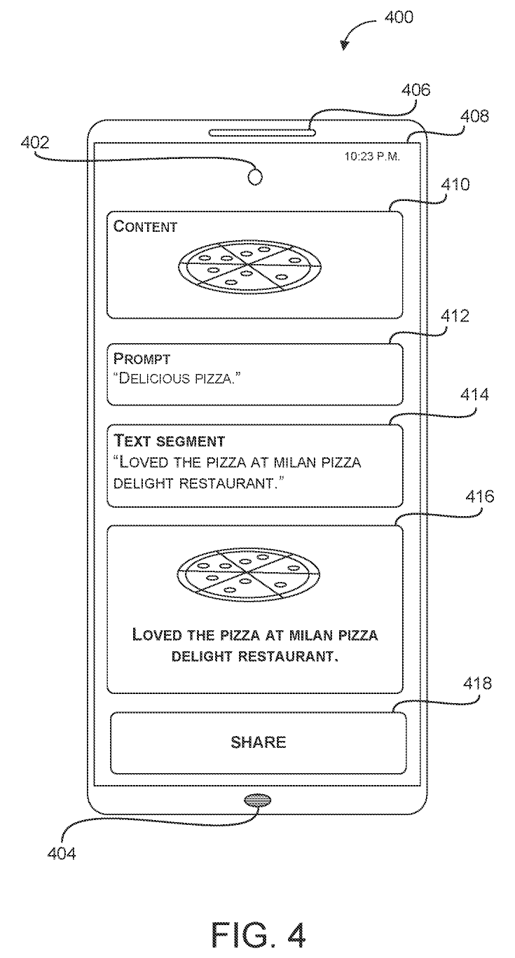

FIG. 4 depicts an example of generating context-based text content based on location context according to example embodiments of the present disclosure. A computing device 400 can include one or more features and/or capabilities of the computing device 102, the server computing system 130, the training computing system 150, and/or the computing device 300. Furthermore, the computing device 400 can perform one or more actions and/or operations that can be performed by the computing device 102, the server computing system 130, the training computing system 150, and/or the computing device 300.

The computing device 400 can include an imaging component 402, an audio input component 404, an audio output component 406, a display component 408, content 410, a prompt 412, a text segment 414, context-based text content 416, and/or interface element 418.

The computing device 400 can be configured to perform one or more operations comprising sending, receiving, processing, and/or generating data comprising content data (e.g., content data based on the content 410), context data, and/or other data received by the computing device 400 (e.g., data associated with one or more prompts). In some embodiments, the computing device 400 can comprise a mobile computing device (e.g., a smartphone, a tablet computing device, a laptop computing device, and/or a wearable computing device) that can be configured to process data locally and/or receive data from a remote source (e.g., a remote computing device that stores and/or processes data that can comprise content data and/or context data). The data (e.g., content data and/or context data) received by the computing device 400 can be used to generate output comprising one or more context-based text segments (e.g., the text segment 414) based on the content 410 and/or one or more prompts (e.g., the prompt 412). Further, the computing device 400 can be configured to generate output comprising context-based text content (e.g., context-based text content 416) that can comprise the content 410 and/or the text segment 414.

Further, the computing device 400 can implement an interface (e.g., a graphical user interface) that is configured to receive one or more inputs (e.g., touch inputs and/or audio inputs) from a user and perform operations that can comprise generating the text segment 414 and/or the context-based text content 416. In some embodiments, the computing device 400 can generate one or more audio indications (e.g., generating audio comprising synthetic speech that voice that announces the text segment 414 via the audio output component 406 (e.g., a loudspeaker) of the computing device 400).

In this example, the computing device 400 has received the content 410, which can comprise an image and/or video segment of a pizza that is displayed on the display component 408. In some embodiments, the content 410 can comprise one or more audio segments (e.g., music or sound effects) that can accompany an image or video or be included without an accompanying image or video. Further, the computing device 400 has received the prompt 412, which is displayed on the display component 408. The prompt 412 indicates “DELICIOUS PIZZA.” In some embodiments, the prompt 412 is optional and the text segment 414 and/or the context-based text content 416 can be generated without receiving or using the prompt 412.

The computing device 400 can determine one or more contexts based on content data associated with the content 410 and/or the prompt 412. For example, the computing device 400 can determine that the content data associated with the content 410 comprises location data (e.g., a latitude, longitude, and/or altitude) indicating the location of the restaurant at which the image of the pizza was captured. Further, the computing device 400 can use the location data to determine that the restaurant “MILAN PIZZA DELIGHT” is located at the geographic location indicated by the location data.

The computing device 400 can use content data (e.g., content data associated with the content 410) and/or context data (e.g., context data associated with the content 410 and/or the prompt 412) as input to one or more machine-learned models that can be implemented on the computing device 400 and/or that are implemented on a remote computing device that is able to send data to and/or receive data from the computing device 400. The one or more machine-learned models can be configured and/or trained to recognize and/or classify one or more features of the content data, the context data, and/or the prompt 412. For example, the one or more machine-learned models can perform image recognition operations and/or image classification operations to determine that the content 410 is an image of a pizza. Further, the one or more machine-learned models can recognize and/or classify one or more features of the prompt 412 and determine that the prompt 412 is a positive statement with respect to the pizza. The one or more machine-learned models can also use the context (e.g., the location data indicating that the content 410 was captured at MILAN PIZZA DELIGHT restaurant) to determine that the pizza is from a particular restaurant. The one or more machine-learned models can then use the content, context, and/or prompt features that were determined to generate the text segment 414 which indicates “LOVED THE PIZZA AT MILAN PIZZA DELIGHT RESTAURANT.”

The text segment 414 can be displayed on the display component 408. In this example, the text segment 414 indicates “LOVED THE PIZZA AT MILAN PIZZA DELIGHT RESTAURANT.” The text segment 414 can be based on the content data (e.g., content data associated with the content 410) and/or context data (e.g., context data associated with the content 410 and/or the prompt 412). The text segment 414 can be modified based on one or more rules (e.g., one or more filters) that can be applied to the text segment 414. For example, a filter can be used to remove and/or change certain words (e.g., profane language).

In some embodiments, the computing device 400 can generate the text segment 414 via the audio output component 406. For example, the computing device 400 can generate a synthetic voice that reads the text segment 414 via the audio output component 406.

The computing device 400 can generate the context-based text content 416. The context-based text content 416 can be displayed on the display component 408 and can comprise the content 410 and/or the text segment 414. In this example, the context-based text content 416 comprises the image of the pizza from the content 410 and the text segment 414. Additionally, the interface element 418 which indicates “SHARE” can be used to send the context-based text content 416 via one or more applications comprising a social media application, a text message application, and/or an email application. Further, the context-based text content 416 can be used to generate a link note that can be shared with one or more users, one or more user groups, and/or embedded in a web resource. The context-based text content 416 can be shared based on the computing device 400 detecting a user touching the portion of the user interface that comprises the interface element 418.

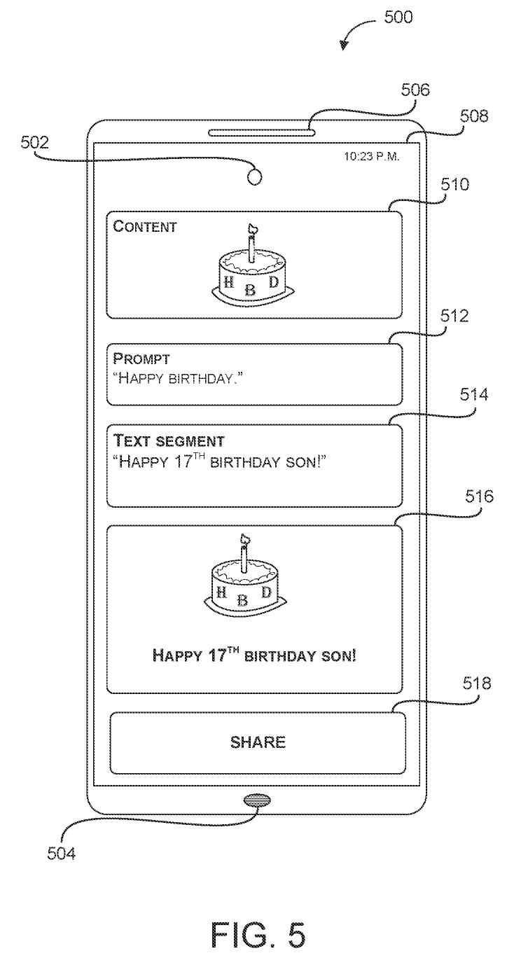

FIG. 5 depicts an example of generating context-based text content based on temporal context according to example embodiments of the present disclosure. A computing device 500 can include one or more features and/or capabilities of the computing device 102, the server computing system 130, the training computing system 150, the computing device 300, and/or the computing device 400. Furthermore, the computing device 500 can perform one or more actions and/or operations that can be performed by the computing device 102, the server computing system 130, the training computing system 150, the computing device 300, and/or the computing device 500.

The computing device 500 can include an imaging component 502, an audio input component 504, an audio output component 506, a display component 508, content 510, a prompt 512, a text segment 514, context-based text content 516, and/or interface element 518.

The computing device 500 can be configured to perform one or more operations comprising sending, receiving, processing, and/or generating data comprising content data (e.g., content data based on the content 510), context data, and/or other data received by the computing device 500 (e.g., data associated with one or more prompts). Further, the computing device 500 can be configured to generate the text segment 514 and/or the context-based text content 516.

In this example, the computing device 500 has received the content 510, which comprises an image and/or a video of a birthday cake that is displayed on the display component 508. In some embodiments, the content 510 can comprise one or more audio segments (e.g., music or sound effects) that can accompany an image or video or be included without an accompanying image or video. Further, the computing device 500 has received the prompt 512, which is displayed on the display component 508. The prompt 512 indicates “HAPPY BIRTHDAY.” In some embodiments, the prompt 512 is optional and the text segment 514 and/or the context-based text content 516 can be generated without receiving or using the prompt 512.

The computing device 500 can determine one or more contexts based on content data associated with the content 510 and/or the prompt 512. For example, the computing device 500 can determine that the content data associated with the content 510 comprises temporal data (e.g., a time of day, day of the week, day, month, and/or year) indicating a time at which the image of the birthday cake was captured. Further, the computing device 500 can determine an age and/or date of birth of the sender and/or intended recipient of the context-based text content 516 based on temporal data associated with the sender and/or intended recipient of the context-based text content 516 (e.g., the son of the person sending the content 510). For example, the sender of the context-based text content 616 can be a father sending the context-based text content 516 to his son and wishing the son a happy birthday. The computing device 500 can determine the temporal context based on data that can comprise calendar data (e.g., the fathers calendar indicates the date of the son’s birthday) or other data indicating the date of the son’s birthday.

The computing device 500 can use content data (e.g., content data associated with the content 510) and/or context data (e.g., context data associated with the content 510 and/or the prompt 512) as input to one or more machine-learned models that can be implemented on the computing device 500 and/or that are implemented on a remote computing device that is able to send data to and/or receive data from the computing device 500. The one or more machine-learned models can be configured and/or trained to recognize and/or classify one or more features of the content data, the context data, and/or the prompt 512. For example, the one or more machine-learned models can perform image recognition operations and/or image classification operations to determine that the content 510 is an image of a birthday cake. Further, the one or more machine-learned models can recognize and/or classify one or more features of the prompt 512 and determine that the prompt 512 is a congratulatory statement with respect to the birthday cake’s recipient. The one or more machine-learned models can also use the context (e.g., the temporal data indicating that the content 510 is associated with a particular person) to determine that the birthday greeting is related to a seventeenth birthday for the sender’s son. The one or more machine-learned models can then use the content, context, and/or prompt features that were determined to generate the text segment 514 which indicates “HAPPY 17^{TH} BIRTHDAY SON.”

The text segment 514 can be displayed on the display component 508. In this example, the text segment 514 indicates “HAPPY 17^{TH} BIRTHDAY SON.” The text segment 514 can be based on the content data (e.g., content data associated with the content 510) and/or context data (e.g., context data associated with the content 510 and/or the prompt 512). The text segment 514 can be modified based on one or more rules (e.g., one or more filters) that can be applied to the text segment 514. For example, a filter can be used to remove and/or change certain words (e.g., profane language). In some embodiments, the computing device 500 can generate the text segment 514 via the audio output component 506. For example, the computing device 500 can generate a synthetic voice that reads the text segment 514 via the audio output component 506.

The computing device 500 can generate the context-based text content 516. The context-based text content 516 can be displayed on the display component 508 and can comprise the content 510 and/or the text segment 514. In this example, the context-based text content 516 comprises the image of the birthday cake from the content 510 and the text segment 514. Additionally, the interface element 518 which indicates “SHARE” can be used to send the context-based text content 516 via one or more applications comprising a social media application, a text message application, and/or an email application. Further, the context-based text content 516 can be used to generate a link note that can be shared with one or more users, one or more user groups, and/or embedded in a web resource. The context-based text content 516 can be shared based on the computing device 500 detecting a user touching the portion of the user interface that comprises the interface element 518.

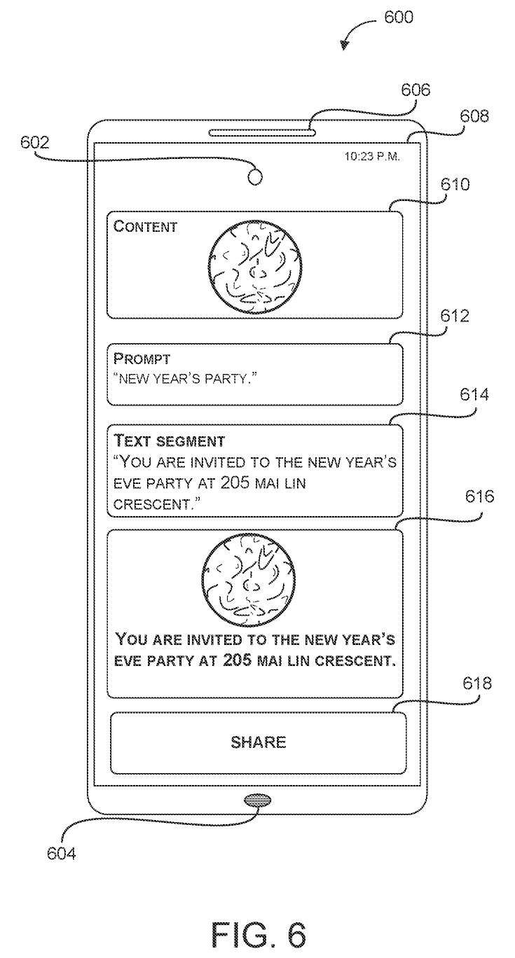

FIG. 6 depicts an example of generating context-based text content based on event context according to example embodiments of the present disclosure. A computing device 600 can comprise one or more features and/or capabilities of the computing device 102, the server computing system 130, the training computing system 150, the computing device 300, and/or the computing device 500.

The computing device 600 can include an imaging component 602, an audio input component 604, an audio output component 606, a display component 608, content 610, a prompt 612, a text segment 614, context-based text content 616, and/or interface element 618.

The computing device 600 can be configured to perform one or more operations comprising sending, receiving, processing, and/or generating data comprising content data (e.g., content data based on the content 610), context data, and/or other data received by the computing device 600 (e.g., data associated with one or more prompts). Further, the computing device 600 can be configured to generate the text segment 614 and/or the context-based text content 616.

In this example, the computing device 600 has received the content 610, which comprises an image and/or video of the moon that is displayed on the display component 608. In some embodiments, the content 610 can comprise one or more audio segments (e.g., music or sound effects) that can accompany an image or video or be included without an accompanying image or video. Further, the computing device 600 has received the prompt 612, which is displayed on the display component 608. The prompt 612 indicates “NEW YEARS PARTY.” In some embodiments, the prompt 612 is optional and the text segment 614 and/or the context-based text content 616 can be generated without receiving or using the prompt 612.

The computing device 600 can determine one or more contexts based on content data associated with the content 610 and/or the prompt 612. For example, the computing device 600 can determine that the content data associated with the content 610 comprises event data (e.g., a calendar entry from a user’s calendar) indicating that a New Year’s Eve party is scheduled to take place at a particular location indicated in the event data. Further, the computing device 600 can use the event data to determine that the location of the New Year’s Eve party is “205 MAI LIN CRESCENT.” The computing device 600 can also determine, based on a contacts list and previous communications between the user of the computing device 600 and the intended recipient of the context-based text content 616, that the intended recipient of the context-based text content 616 is a friend of the user of the computing device 600.

The computing device 600 can use content data (e.g., content data associated with the content 610) and/or context data (e.g., context data associated with the content 610 and/or the prompt 612) as input to one or more machine-learned models that can be implemented on the computing device 600 and/or that are implemented on a remote computing device that is able to send data to and/or receive data from the computing device 600. The one or more machine-learned models can be configured and/or trained to recognize and/or classify one or more features of the content data, the context data, and/or the prompt 612. For example, the one or more machine-learned models can perform image recognition operations and/or image classification operations to determine that the content 610 is an image of the moon which can be associated with the evening and/or events that occur during the evening. Further, the one or more machine-learned models can recognize and/or classify one or more features of the prompt 612 and determine that the prompt 612 is a notification of an event (e.g., a New Year’s Eve party). The one or more machine-learned models can also use the context (e.g., the event data indicating a calendar event at 205 Mai Lin crescent) to determine the location at which the New Year’s Eve party will take place. The one or more machine-learned models can then use the content, context, and/or prompt features that were determined to generate the text segment 614 which indicates “YOU ARE INVITED TO THE NEW YEAR’S EVE PARTY AT 205 MAI LIN CRESCENT.”

The text segment 614 can be displayed on the display component 608. In this example, the text segment 614 indicates “YOU ARE INVITED TO THE NEW YEAR’S EVE PARTY AT 205 MAI LIN CRESCENT.” The text segment 614 can be based on the content data (e.g., content data associated with the content 610) and/or context data (e.g., context data associated with the content 610 and/or the prompt 612). The text segment 614 can be modified based on one or more rules (e.g., one or more filters) that can be applied to the text segment 614. For example, a filter can be used to remove and/or change certain words (e.g., profane language).

In some embodiments, the computing device 600 can generate the text segment 614 via the audio output component 606. For example, the computing device 600 can generate a synthetic voice that reads the text segment 614 via the audio output component 606.

The computing device 600 can generate the context-based text content 616. The context-based text content 616 can be displayed on the display component 608 and can comprise the content 610 and/or the text segment 614. In this example, the context-based text content 616 comprises the image of the moon from the content 610 and the text segment 614. Additionally, the interface element 618, which indicates “SHARE” can be used to send the context-based text content 616 via one or more applications comprising a social media application, a text message application, and/or an email application. Further, the context-based text content 616 can be used to generate a link note that can be shared with one or more users, one or more user groups, and/or embedded in a web resource. The context-based text content 616 can be shared based on the computing device 600 detecting a user touching the portion of the user interface that comprises the interface element 618.

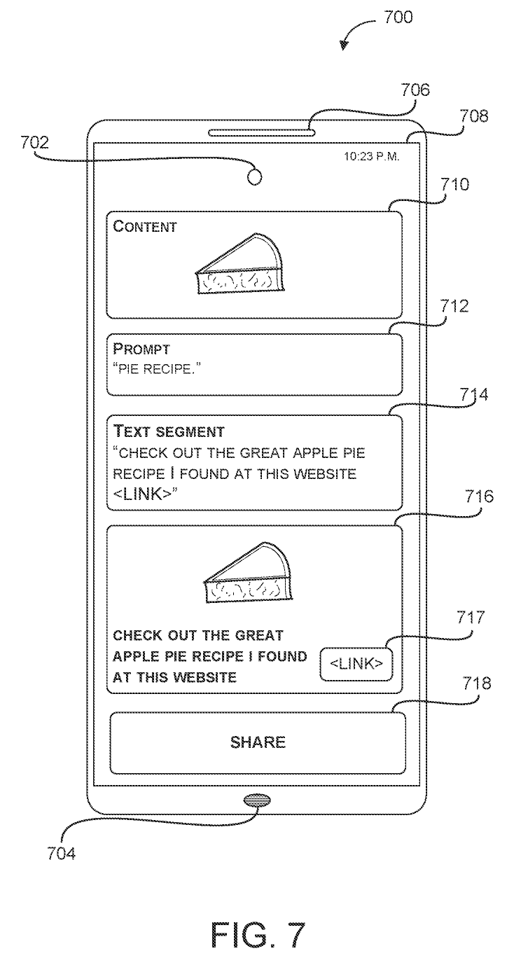

FIG. 7 depicts an example of generating context-based text content based on application context according to example embodiments of the present disclosure. A computing device 700 can include one or more features and/or capabilities of the computing device 102, the server computing system 130, the training computing system 150, the computing device 300, and/or the computing device 500.

The computing device 700 can include an imaging component 702, an audio input component 704, an audio output component 706, a display component 708, content 710, a prompt 712, a text segment 714, context-based text content 716, link 717, and/or interface element 718.

The computing device 700 can be configured to perform one or more operations comprising sending, receiving, processing, and/or generating data comprising content data (e.g., content data based on the content 710), context data, and/or other data received by the computing device 700 (e.g., data associated with one or more prompts). Further, the computing device 700 can be configured to generate the text segment 714 and/or the context-based text content 716.

In this example, the computing device 700 has received the content 710, which comprises an image and/or video of a slice of pie that is displayed on the display component 708. In some embodiments, the content 710 can comprise one or more audio segments (e.g., music or sound effects) that can accompany an image or video or be included without an accompanying image or video. Further, the computing device 700 has received the prompt 712, which is displayed on the display component 708. The prompt 712 indicates “PIE RECIPE.” In some embodiments, the prompt 712 is optional and the text segment 714 and/or the context-based text content 716 can be generated without receiving or using the prompt 712.

The computing device 700 can determine one or more contexts based on content data associated with the content 710 and/or the prompt 712. For example, the computing device 700 can determine that the content data associated with the content 710 comprises application data (e.g., application data from a web browser that was used to browse a website and/or webpage from which the content 710 captured) indicating the website and/or webpage from which the image of the slice of pie was captured. Further, the computing device 700 can use the application data to determine the website and/or webpage from which the pie recipe was obtained and/or a link to the website and/or webpage with the recipe.

The computing device 700 can use content data (e.g., content data associated with the content 710) and/or context data (e.g., context data associated with the content 710 and/or the prompt 712) as input to one or more machine-learned models that can be implemented on the computing device 700 and/or that are implemented on a remote computing device that is able to send data to and/or receive data from the computing device 700. The one or more machine-learned models can be configured and/or trained to recognize and/or classify one or more features of the content data, the context data, and/or the prompt 712. For example, the one or more machine-learned models can perform image recognition operations and/or image classification operations to determine that the content 710 is an image of a slice of apple pie. Further, the one or more machine-learned models can recognize and/or classify one or more features of the prompt 712 and determine that the prompt 712 is a statement about a recipe to make the pie. The one or more machine-learned models can also use the context (e.g., the application data indicating the website and/or webpage from which the image of the pie was obtained) to determine a web link to the website and/or webpage with the apple pie recipe. The one or more machine-learned models can then use the content, context, and/or prompt features that were determined to generate the text segment 714 which indicates “CHECK OUT THE GREAT APPLE PIE RECIPE I FOUND AT THIS WEBSITE <LINK>” and includes a link 717 (“<LINK>” which can comprise a hyperlink) to the website and/or webpage with the apple pie recipe.

The text segment 714 can be displayed on the display component 708. In this example, the text segment 714 indicates “CHECK OUT THE GREAT APPLE PIE RECIPE I FOUND AT THIS WEBSITE <LINK>.” The text segment 714 can be based on the content data (e.g., content data associated with the content 710) and/or context data (e.g., context data associated with the content 710 and/or the prompt 712).

In some embodiments, the computing device 700 can generate the text segment 714 via the audio output component 706. For example, the computing device 700 can generate a synthetic voice that reads the text segment 714 via the audio output component 706.

The computing device 700 can generate the context-based text content 716. The context-based text content 716 can be displayed on the display component 708 and can comprise the content 710 and/or the text segment 714. In this example, the context-based text content 716 comprises the image of the slice of pie from the content 710 and the text segment 714. Additionally, the interface element 718 which indicates “SHARE” can be used to send the context-based text content 716 and/or the link 717 via one or more applications comprising a social media application, a text message application, and/or an email application. Further, the context-based text content 716 can be used to generate a link note that can be shared with one or more users, one or more user groups, and/or included in a web resource. In some embodiments, a link note based on the context-based text content 716 can include the link 717. The context-based text content 716 can be shared based on the computing device 700 detecting a user touching the portion of the user interface that comprises the interface element 718.

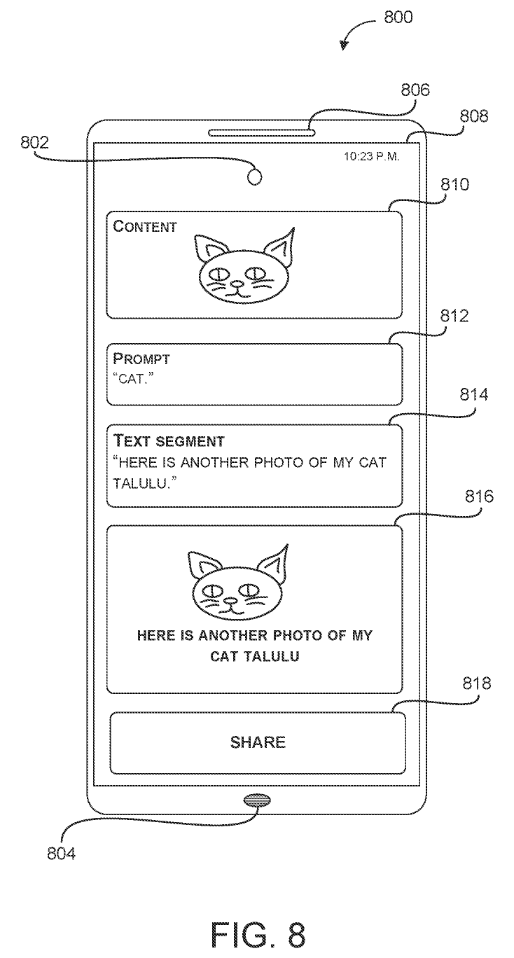

FIG. 8 depicts an example of generating context-based text content based on user context according to example embodiments of the present disclosure. A computing device 800 can include one or more features and/or capabilities of the computing device 102, the server computing system 130, the training computing system 150, the computing device 300, and/or the computing device 500.

The computing device 800 can include an imaging component 802, an audio input component 804, an audio output component 806, a display component 808, content 810, a prompt 812, a text segment 814, context-based text content 816, and/or interface element 818.

The computing device 800 can be configured to perform one or more operations comprising sending, receiving, processing, and/or generating data comprising content data (e.g., content data based on the content 810), context data, and/or other data received by the computing device 800 (e.g., data associated with one or more prompts). Further, the computing device 800 can be configured to generate the text segment 814 and/or the context-based text content 816.

In this example, the computing device 800 has received the content 810, which comprises an image and/or a video of a cat that is displayed on the display component 808. In some embodiments, the content 810 can comprise one or more audio segments (e.g., music or sound effects) that can accompany an image or video or be included without an accompanying image or video. Further, the computing device 800 has received the prompt 812, which is displayed on the display component 808. The prompt 812 indicates “CAT.” In some embodiments, the prompt 812 is optional and the text segment 814 and/or the context-based text content 816 can be generated without receiving or using the prompt 812.

The computing device 800 can determine one or more contexts based on content data associated with the content 810 and/or the prompt 812. For example, the computing device 800 can determine that the content data associated with the content 810 is associated with a particular user (e.g., a user that generated the content 810). Further, the computing device 800 can access data associated with the user (e.g., a photo repository associated with a user) that indicates that the cat in the image is the user’s cat and that the name of the cat is “TALULU.”

In some embodiments, determination of the one or more contexts associated with the content 410 can be based on the identity of the user associated with the content 410 and/or the prompt 412. Determination of the identity of the user can be based on data which can include login information (e.g., a user logging into an account associated with an application that is used to generate or receive the content 410). Further, determination of the identity of the user can be based on use of an identity determination device which can include a fingerprint reader or face scanning. For example, the imaging component 402 (e.g., a camera) can be configured to capture an image of a user of the computing device 400 that can be identified based on performing image recognition operations on the image to determine the identity of the user and, after further authenticating the user (e.g., biometric authentication and/or a passcode) and receiving the user’s express authorization to access the user’s content data and/or context data, can securely access content data and/or context data (e.g., encrypted content data and/or encrypted context data) that is associated with that user.

The computing device 800 can use content data (e.g., content data associated with the content 810) and/or context data (e.g., context data associated with the content 810 and/or the prompt 812) as input to one or more machine-learned models that can be implemented on the computing device 800 and/or that are implemented on a remote computing device that is able to send data to and/or receive data from the computing device 800. The one or more machine-learned models can be configured and/or trained to recognize and/or classify one or more features of the content data, the context data, and/or the prompt 812. For example, the one or more machine-learned models can perform image recognition and/or classification operations to determine that the content 810 is an image of a cat. Further, the one or more machine-learned models can recognize and/or classify one or more features of the prompt 812 and determine that the prompt 812 refers to the cat in the content 810. The one or more machine-learned models can also use the context (e.g., the data indicating that the cat is associated with the user and that the cat’s name is “TALULU”) to determine that the cat is the user’s cat. The one or more machine-learned models can then use the content, context, and/or prompt features that were determined to generate the text segment 814 which indicates “HERE IS ANOTHER PHOTO OF MY CAT TALULU.”

The text segment 814 can be displayed on the display component 808. In this example, the text segment 814 indicates “HERE IS ANOTHER PHOTO OF MY CAT TALULU.” The text segment 814 can be based on the content data (e.g., content data associated with the content 810) and/or context data (e.g., context data associated with the content 810 and/or the prompt 812). The text segment 814 can be modified based on one or more rules (e.g., one or more filters) that can be applied to the text segment 814. For example, a filter can be used to remove and/or change certain words (e.g., profane language).

In some embodiments, the computing device 800 can generate the text segment 814 via the audio output component 806. For example, the computing device 800 can generate a synthetic voice that reads the text segment 814 via the audio output component 806.

The computing device 800 can generate the context-based text content 816. The context-based text content 816 can be displayed on the display component 808 and can comprise the content 810 and/or the text segment 814. In this example, the context-based text content 816 comprises the image of the cat from the content 810 and the text segment 814. Additionally, the interface element 818 which indicates “SHARE” can be used to send the context-based text content 816 via one or more applications comprising a social media application, a text message application, and/or an email application. Further, the context-based text content 816 can be used to generate a link note that can be shared with one or more users, one or more user groups, and/or included in a web resource. The context-based text content 816 can be shared based on the computing device 800 detecting a user touching the portion of the user interface that comprises the interface element 818.

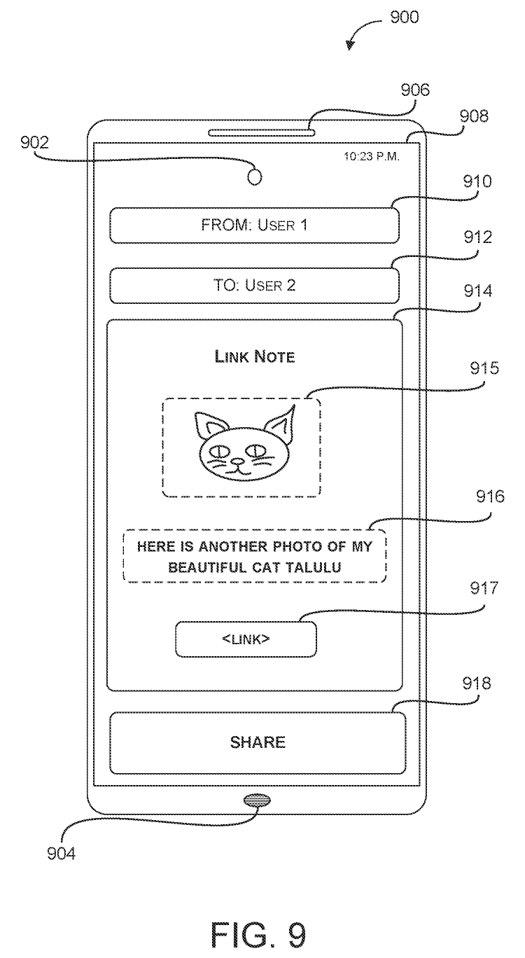

FIG. 9 depicts an example of a link note based on context-based text content according to example embodiments of the present disclosure. A computing device 900 can include one or more features and/or capabilities of the computing device 102, the server computing system 130, the training computing system 150, the computing device 300, and/or the computing device 500.

The computing device 900 can include an imaging component 902, an audio input component 904, an audio output component 906, a display component 908, sender indication 910, a receiver indication 912, a link note 914, content 915, text segment 916, link 917, and/or interface element 918.

The computing device 900 can be configured to perform one or more operations comprising sending, receiving, processing, and/or generating data comprising link note data (e.g., link note data based on the link note 914), content data, context data, and/or other data received by the computing device 900 (e.g., data associated with one or more prompts). Further, the computing device 900 can be configured to generate the link note 914.

In this example, the computing device 900 has generated and/or accessed the link note 914 which comprises content 915 (e.g., an image of a cat), the text segment 916 which indicates “HERE IS ANOTHER PHOTO OF MY BEAUTIFUL CAT TALULU” and a link 917 that indicates “<LINK>” and comprises a link to a web resource (e.g., a social media posting from which the content 915 was obtained) that are displayed on the display component 908. In some embodiments, the computing device 900 can generate and/or access the link note 914 based on one or more interactions by the user with an interface element (e.g., the interface element 818 that is described with respect to FIG. 8). Further, the computing device 900 can generate the sender indication 910 which indicates “FROM: USER 1” and can be used to indicate the user that is sending the link note 914. The computing device 900 can also generate the receiver indication 912 which indicates “TO: USER 2” and can be used to indicate the user that can receive the link note 914.

Additionally, the interface element 918 which indicates “SHARE” can be used to send the link note 914 to one or more users (e.g., “USER 2” indicated in the receiver indication 912). For example, the link note 914 can be shared based on the computing device 900 detecting a user touching the portion of the user interface that comprises the interface element 918. In some embodiments, the link note 914 can be included in one or more web resources. For example, the link note 914 can be included in a search result for cats or the name “TALULU,” a social media post, and/or a review website.

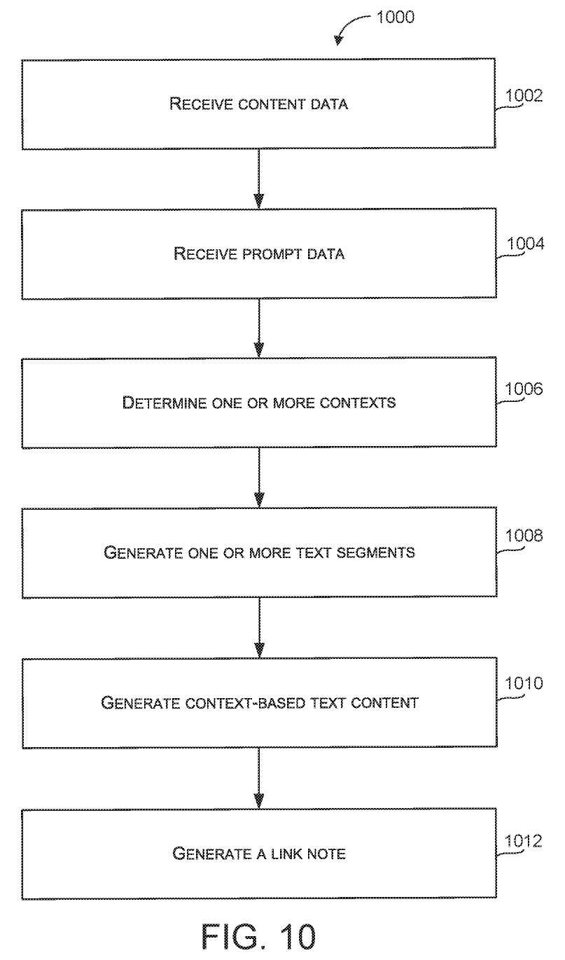

FIG. 10 depicts a flow chart diagram of an example method of generating context-based text according to example embodiments of the present disclosure. One or more portions of the method 1000 can be executed and/or implemented on one or more computing devices or computing systems comprising, for example, the computing device 102, the server computing system 130, the training computing system 150, and/or the computing device 300. Further, one or more portions of the method 1000 can be executed or implemented as an algorithm on the hardware devices or systems disclosed herein. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include receiving content data comprising content associated with one or more data modalities. For example, the server computing system 130 can receive content data comprising an image of a helicopter. The content data can be received from a local device and/or from a remote source (e.g., a remote computing system) via a network such as the network 180.

At 1004, the method 1000 can include receiving prompt data comprising one or more prompts that can be associated with the content data. For example, the server computing system 130 can receive data (e.g., prompt data) comprising one or more text-based prompts. The prompt data can be received from a local device and/or from a remote source (e.g., a remote computing system) via a network such as the network 180.

At 1006, the method 1000 can include determining one or more contexts associated with the content data. Context data can be generated based on the one or more contexts. For example, the server computing system 130 can access the search history of a user to determine context comprising the search queries that the user had made prior to the content data being received. Further, the server computing system 130 can generate context data based on the context comprising the search queries that the user had made prior to the content data being received.

At 1008, the method 1000 can include generating and/or determining, based on inputting the content data, the prompt data, and/or context data based on the one or more contexts into one or more machine-learned models, one or more context-based text segments based on the content data. The one or more machine-learned models can be configured and/or trained to generate the one or more context-based text segments based on detection, recognition, and/or classification of one or more features of the content data, the prompt data, and/or the context data. For example, the server computing system 130 can implement one or more machine-learned models that are configured and/or trained to generate one or more context-based text segments based on input comprising an image and context associated with a location at which the image was captured.

At 1010, the method 1000 can include context-based text content based on the one or more context-based text segments. For example, the server computing system 130 can generate an image of a birthday cake comprising the text segments indicating “HAPPY BIRTHDAY.”

At 1012, the method 1000 can include generating a link note based on the context-based text content. For example, the server computing system 130 can generate a link note comprising the context-based text content and a link (e.g., a hyperlink) to a social media post associated with the content of the context-based text content.

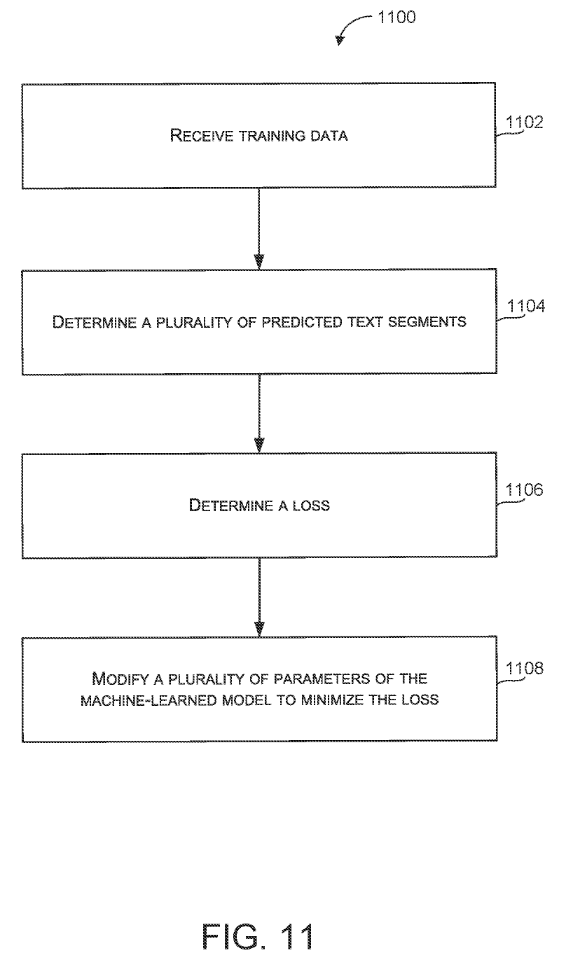

FIG. 11 depicts a flow chart diagram of an example method of training machine-learned models to generate context-based text segments according to example embodiments of the present disclosure. One or more portions of the method 1100 can be executed and/or implemented on one or more computing devices or computing systems comprising, for example, the computing device 102, the server computing system 130, the training computing system 150, and/or the computing device 300. Further, one or more portions of the method 1100 can be executed or implemented as an algorithm on the hardware devices or systems disclosed herein. In some embodiments, one or more portions of the method 1100 can be performed as part of the method 1000 that is described with respect to FIG. 10. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include receiving training data comprising a plurality of training data inputs and a corresponding plurality of ground-truth text segments. For example, the server computing system 130 can receive training data comprising a plurality of training data inputs. The plurality of training data inputs can comprise a plurality of training images, a plurality of training audio segments, a plurality of training text segments, and/or a plurality of training video segments. For example, the plurality of training data inputs can comprise images of cats playing with various objects (e.g., string or ping-pong balls) and the plurality of ground-truth text segments can comprise descriptions of the cats playing with the objects.

At 1104, the method 1100 can include determining, based on inputting the plurality of training data inputs into one or more machine-learned models, a plurality of predicted text segments. For example, the server computing system 130 can implement one or more machine-learned models. Further, based on inputting the plurality of training data inputs into the one or more machine-learned models, the one or more machine-learned models can perform one or more operations (e.g., detection, recognition, and/or classification operations) on the plurality of training data inputs and generate an output comprising a plurality of predicted text segments.

At 1106, the method 1100 can include determining a loss based on one or more differences between the plurality of predicted text segments and the plurality of ground-truth text segments. For example, over a plurality of iterations, the server computing system 130 can determine a loss (e.g., a cross-entropy loss) based on one or more differences between the plurality of predicted text segments and the plurality of ground-truth text segments. The one or more differences between the plurality of predicted text segments and the plurality of ground-truth text segments can be based on one or more comparisons of the plurality of predicted text segments to the plurality of ground-truth text segments.

At 1108, the method 1100 can include modifying a plurality of parameters of the one or more machine-learned models to minimize the loss. For example, the server computing system 130 can modify a plurality of weights of the plurality of parameters so that the weights of the plurality of parameters that contribute to reducing the loss (e.g., the parameters that increase the accuracy of the one or more machine-learned models generating a plurality of predicted text segments that are accurate) are increased and/or the weights of the plurality of parameters that contribute to increasing the loss (e.g., the parameters that decrease the accuracy of the one or more machine-learned models generating a plurality of predicted text segments that are accurate) are decreased. The plurality of weights of the plurality of parameters can be modified until some threshold loss (e.g., a minimized loss) that corresponds to a high accuracy of the plurality of predicted text segments is exceeded.

Further to the descriptions above, a user may be provided with controls allowing the user to make an election as to both if and/or when systems, programs, or features described herein may enable collection of user information (e.g., image information), and if the user is sent content or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating context-based text content, the computer-implemented method comprising:
receiving, by a computing system comprising one or more processors, content data comprising content associated with one or more data modalities;
determining, by the computing system, one or more contexts associated with the content data;
generating, by the computing system, based on inputting the content data and context data based on the one or more contexts into one or more machine-learned models, one or more context-based text segments associated with the content data, wherein the one or more machine-learned models are configured to generate the one or more context-based text segments based on recognition of one or more features of the content data and the context data; and
generating, by the computing system, context-based text content based on the one or more context-based text segments.

2. The computer-implemented method of claim 1, further comprising:
receiving, by the computing system, prompt data comprising one or more prompts associated with the content data, wherein the one or more machine-learned models are further configured to generate the one or more context-based text segments based on recognition of one or more features of the one or more prompts.

3. The computer-implemented method of claim 1, further comprising:
generating, by the computing system, a link note comprising the context-based text content and one or more links to one or more web resources associated with the context-based text content, wherein the one or more web resources comprise one or more search results, one or more web pages, one or more database entries, or one or more social media posts.

4. The computer-implemented method of claim 1, wherein the one or more contexts comprise information associated with one or more locations, and wherein the one or more machine-learned models are configured to determine the one or more context-based text segments based on the information associated with the one or more locations.

5. The computer-implemented method of claim 1, wherein the one or more contexts comprise one or more temporal indications associated with one or more times at which the content data was generated, and wherein the one or more machine-learned models are configured to determine the one or more context-based text segments based on the one or more temporal indications.

6. The computer-implemented method of claim 1, wherein the one or more contexts comprise information associated with one or more events associated with the content data, and wherein the one or more machine-learned models are configured to generate the one or more context-based text segments based on the information associated with the one or more events.

7. The computer-implemented method of claim 1, wherein the one or more contexts comprise information associated with one or more applications associated with the content data, and wherein the one or more machine-learned models are configured to classify the one or more applications and generate the one or more context-based text segments based on the information associated with the one or more applications.

8. The computer-implemented method of claim 1, wherein the one or more contexts comprise one or more search queries associated with the content data, wherein the one or more machine-learned models are configured to classify the one or more search queries and generate the one or more context-based text segments based on the one or more search queries.

9. The computer-implemented method of claim 1, wherein the one or more machine-learned models are configured to identify information associated with one or more users in the content data and generate the context-based text segments based on the information associated with the one or more users.

10. The computer-implemented method of claim 1, wherein the content data comprises one or more images, one or more audio segments, or one or more video segments.

11. The computer-implemented method of claim 1, wherein the one or more machine-learned models are trained to generate the one or more context-based text segments, and wherein the training of the one or more machine-learned models comprises:
receiving, by the computing system, training data comprising a plurality of training data inputs and a corresponding plurality of ground-truth text segments, wherein the plurality of training data inputs comprise a plurality of training images, a plurality of training audio segments, a plurality of training text segments, or a plurality of training video segments;
determining, by the computing system, based on inputting the plurality of training data inputs into the one or more machine-learned models, a plurality of predicted text segments;
determining, by the computing system, a loss based on one or more differences between the plurality of predicted text segments and the corresponding plurality of ground-truth text segments; and
modifying, by the computing system, a plurality of parameters of the one or more machine-learned models to minimize the loss.

12. The computer-implemented method of claim 1, wherein the one or more machine-learned models comprise one or more multimodal transformer models that are trained to generate the one or more context-based text segments based on training data comprising a plurality of embeddings based on training data comprising training content data or training context data.

13. The computer-implemented method of claim 12, wherein the training content data comprises a plurality of training images, a plurality of training audio segments, a plurality of training video segments, and a corresponding plurality of ground-truth text segments, and wherein the training context data comprises a plurality of training locations, a plurality of temporal indications, a plurality of training applications, or a plurality of training search queries.

14. The computer-implemented method of claim 1, wherein the one or more machine-learned models are trained based on training data comprising a plurality of training context-based text segments of a user associated with the content data, wherein the one or more machine-learned models are configured to generate the context-based text content in a visual style based on the plurality of training context-based texts, and wherein the visual style comprises a color scheme or one or more font types of the one or more context-based text segments.

15. The computer-implemented method of claim 1, wherein the one or more machine-learned models are trained to generate the one or more context-based text segments based on training data comprising a plurality of training text segments of a user associated with the content data, and wherein the one or more machine-learned models are configured to generate the one or more context-based text segments in a writing style based on the plurality of training text segments.

16. One or more tangible non-transitory computer-readable media storing computer-readable instructions that when executed by one or more processors cause the one or more processors to perform operations, the operations comprising:
receiving content data comprising content associated with one or more data modalities;
determining one or more contexts associated with the content data;
generating, based on inputting the content data and context data based on the one or more contexts into one or more machine-learned models, one or more context-based text segments associated with the content data, wherein the one or more machine-learned models are configured to generate the one or more context-based text segments based on recognition of one or more features of the content data and the context data; and
generating context-based text content based on the one or more context-based text segments.

17. The one or more tangible non-transitory computer-readable media of claim 16, wherein the one or more machine-learned models comprise one or more multimodal transformer models that are trained to generate the one or more context-based text segments based on training data comprising a plurality of embeddings based on training data comprising training content data or training context data.

18. A computing system comprising:
one or more processors;
one or more non-transitory computer-readable media storing instructions that when executed by the one or more processors cause the one or more processors to perform operations comprising:
receiving content data comprising content associated with one or more data modalities;
determining one or more contexts associated with the content data;
generating, based on inputting the content data and context data based on the one or more contexts into one or more machine-learned models, one or more context-based text segments associated with the content data, wherein the one or more machine-learned models are configured to generate the one or more context-based text segments based on recognition of one or more features of the content data and the context data; and
generating context-based text content based on the one or more context-based text segments.

19. The computing system of claim 18, wherein the one or more machine-learned models comprise one or more multimodal transformer models that are trained to generate the one or more context-based text segments based on training data comprising a plurality of embeddings based on training data comprising training content data or training context data.

20. The computing system of claim 18, wherein the one or more machine-learned models are trained based on training data comprising a plurality of training context-based text segments of a user associated with the content data, wherein the one or more machine-learned models are configured to generate the context-based text content in a visual style based on the plurality of training context-based texts, and wherein the visual style comprises a color scheme or one or more font types of the one or more context-based text segments.
